(19) United States
(12) Patent Application Publication
(10) Pub. No.: US 2007/0106051 A1
(43) Pub. Date: May 10, 2007

(54) Polyfunctional poly(arylene ether) method

(76) Inventors: Alvaro Carrillo, Delmar, NY (US); Erik Rene Delsman, TM Breda (NL); Hua Guo, Selkirk, NY (US); Alexey Kruglov, Glenmont, NY (US); Edward N. Peters, Lenox, MA (US)

Correspondence Address: CANTOR COLBURN, LLP, 55 GRIFFIN ROAD SOUTH, BLOOMFIELD, CT, 06002, US

(21) Appl. No.: 11/272,119

(22) Filed: Nov. 10, 2005

(51) Int. Cl. C08G 61/02

(52) U.S. Cl. 528/86

(57) ABSTRACT

A polyfunctional poly(arylene ether) resin may be prepared by a method that includes oxidatively copolymerizing a monohydric phenol and a polyhydric phenol in an aromatic hydrocarbon solvent in the presence of a catalyst comprising a metal ion and a nitrogen-containing ligand to form a solution comprising a polyfunctional poly(arylene ether) having an intrinsic viscosity of about 0.04 to about 0.3 deciliter per gram at 25° C. in chloroform; and contacting the polyfunctional poly(arylene ether) solution with an aqueous solution of a chelating agent to extract the metal ion from the solution; wherein the chelating agent and metal ion are present in a molar ratio of about 1.0 to about 1.5. The method reduces the formation of a dispersion during the chelation step.

### BACKGROUND OF THE INVENTION

Poly(arylene ether) resins and their blends with styrenic resins are used in many commercial applications that benefit from their temperature resistance, stiffness, impact strength, and dielectric properties. Conventional poly(arylene ether) resins have intrinsic viscosities of about 0.3 to about 0.6 deciliter per gram, as measured in chloroform at 25° C. Conventional poly(arylene ether) resins also have, on average, about one terminal hydroxy group per polymer chain. Recently, some new applications for poly(arylene ether) resins, including compositions for printed circuit board fabrication, have created a need for poly(arylene ether) resins with lower intrinsic viscosities and more than one terminal hydroxy group per polymer chain. However, known synthesis methods are not suitable for the preparation of such low intrinsic viscosity, high functionality poly(arylene ether) resins. For example, as described below, the present inventors found that a conventional method of using an aqueous solution of chelating agent to extract polymerization catalyst metal ion from an organic solution of poly(arylene ether) resin resulted in formation of dispersions that made it difficult to separate the poly(arylene ether) from the polymerization catalyst. There is therefore a need for new poly(arylene ether) synthesis methods that avoid the formation of a dispersion during purification of poly(arylene ether) resins having low intrinsic viscosity and high functionality.

### BRIEF DESCRIPTION OF THE INVENTION

The above-described and other drawbacks are alleviated by a method of preparing a polyfunctional poly(arylene ether) resin, comprising: oxidatively copolymerizing a monohydric phenol and a polyhydric phenol in an aromatic hydrocarbon solvent in the presence of a catalyst comprising a metal ion and a nitrogen-containing ligand to form a solution comprising a polyfunctional poly(arylene ether) having an intrinsic viscosity of about 0.04 to about 0.3 deciliter per gram at 25° C. in chloroform; and contacting the polyfunctional poly(arylene ether) solution with an aqueous solution of a chelating agent to extract the metal ion from the solution; wherein the chelating agent and metal ion are present in a molar ratio of about 1.0 to about 1.5.

Other embodiments, including particular methods of preparing polyfunctional poly(arylene ether) resins, are described in detail, below.

### DETAILED DESCRIPTION OF THE INVENTION

One embodiment is a method of preparing a polyfunctional poly(arylene ether) resin, comprising: oxidatively copolymerizing a monohydric phenol and a polyhydric phenol in an aromatic hydrocarbon solvent in the presence of a catalyst comprising a metal ion and a nitrogen-containing ligand to form a solution comprising a polyfunctional poly(arylene ether) having an intrinsic viscosity of about 0.04 to about 0.3 deciliter per gram at 25° C. in chloroform; and contacting the polyfunctional poly(arylene ether) solution with an aqueous solution of a chelating agent to extract the metal ion from the solution; wherein the chelating agent and metal ion are present in a molar ratio of about 1.0 to about 1.5. In the process of research on methods of preparing poly(arylene ether) resins having low intrinsic viscosity and high functionality, the present inventors discovered that conventional methods of extracting catalyst metal ion from a solution of the poly(arylene ether) resulted in the formation of a dispersion that made it difficult to separate the catalyst metal ion from the poly(arylene ether). In particular, when a poly(arylene ether) having an intrinsic viscosity of 0.04 to about 0.3 deciliter per gram and a functionality of at least about 1.5 terminal hydroxyl groups, on average, per chain, was synthesized by metal-catalyzed polymerization of phenolic monomers in an aromatic solvent, and when the resulting solution of poly(arylene ether) was treated with an aqueous solution of a chelating agent to remove the catalyst metal ion, the agitated mixture of the poly(arylene ether) solution and the aqueous chelating agent solution formed a dispersion that did not readily phase separate when agitation was ceased. Thus, the aqueous solution containing the catalyst metal ion and the organic solution containing the poly(arylene ether) could not readily be separated. After extensive research, the present inventors discovered the formation of a dispersion could be avoided by reducing the concentration of chelating agent in the aqueous solution. It was previously thought that such a reduction in the chelating agent concentration would lead to insufficient removal of catalyst metal ion from the poly(arylene ether), but it was surprisingly discovered that the reduced chelating agent concentrations both avoided the dispersion problem and adequately reduced the concentration of catalyst metal ion in the isolated poly(arylene ether) resin. Specifically, using the chelating agent in an amount of about 1.0 to about 1.5 moles per mole of catalyst metal ion avoided dispersion formation while removing all but a few parts per million by weight of catalyst metal from the poly(arylene ether) resin.

The method comprises oxidatively copolymerizing a monohydric phenol and a polyhydric phenol. The monohydric phenol is a compound having a single phenolic hydroxyl group. In one embodiment, the monohydric phenol has the structure 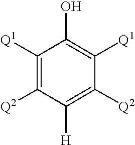
wherein each occurrence of Q¹ is independently halogen, primary or secondary C₁-C₁₂ alkyl, C₂-C₁₂ alkenyl, C₃-C₁₂ alkenylalkyl, C₂-C₁₂ alkynyl, C₃-C₁₂ alkynylalkyl, C₁-C₁₂ aminoalkyl, C₁-C₁₂ hydroxyalkyl, C₆-C₁₂ aryl (including phenyl), C₁-C₁₂ haloalkyl, C₁-C₁₂ hydrocarbonoxy, C₁-C₁₂ halohydrocarbonoxy wherein at least two carbon atoms separate the halogen and oxygen atoms, or the like; and wherein each occurrence of Q² is independently hydrogen, halogen, primary or secondary C₁-C₁₂ alkyl, C₂-C₁₂ alkenyl, C₃-C₁₂ alkenylalkyl, C₂-C₁₂ alkynyl, C₃-C₁₂ alkynylalkyl, C₁-C₁₂ aminoalkyl, C₁-C₁₂ hydroxyalkyl, C₆-C₁₂ aryl (including phenyl), C₁-C₁₂ haloalkyl, C₁-C₁₂ hydrocarbonoxy, C₁-C₁₂ halohydrocarbonoxy wherein at least two carbon atoms separate the halogen and oxygen atoms, or the like. In one embodiment, each occurrence of Q¹ is independently primary or secondary C₁-C₁₂ alkyl, C₂-C₁₂ alkenyl, C₃-C₁₂ alkenylalkyl, or C₆-C₁₂ aryl; and each occurrence of Q² is independently hydrogen or primary or secondary C₁-C₁₂ alkyl. In one embodiment, the monohydric phenol is selected from 2,6-dimethylphenol, 2,3,6-trimethylphenol, and mixtures thereof.

The polyhydric phenol is a compound having two or more phenolic hydroxy groups. The polyhydric phenol preferably comprises two or more arene rings, each with at most one phenolic hydroxy group. In one embodiment, the polyhydric phenol comprises 2 to about 8 phenolic hydroxy groups. In one embodiment, the polyhydric phenol comprises a dihydric phenol (i.e., a compound having two phenolic hydroxyl groups).

The dihydric phenol may have the structure 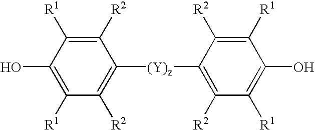
wherein each occurrence of R¹ and R² is independently hydrogen, halogen, primary or secondary C₁-C₁₂ alkyl, C₁-C₁₂ alkenyl, C₁-C₁₂ alkynyl, C₁-C₁₂ aminoalkyl, C₁-C₁₂ hydroxyalkyl, C₆-C₁₂ aryl (including phenyl), C₁-C₁₂ haloalkyl, C₁-C₁₂ hydrocarbonoxy, C₁-C₁₂ halohydrocarbonoxy wherein at least two carbon atoms separate the halogen and oxygen atoms, or the like; z is 0 or 1; and Y is selected from 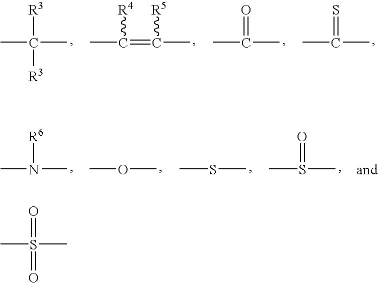
wherein each occurrence of R³—R⁶ is independently hydrogen or C₁-C₁₂ hydrocarbyl. In the embodiment in which Y is 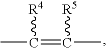
the wavy lines signify that R⁴ and R⁵ may be either cis or trans with respect to each other. In one embodiment, the dihydric phenol has the structure above, wherein each occurrence of R¹ is methyl, each occurrence of R² and R³ is independently hydrogen or methyl. Suitable dihydric phenols include, for example, 1,1-bis(3,5-dimethyl-4-hydroxyphenyl)ethane, 1,1-bis(3-chloro-4-hydroxyphenyl)ethane, 1,1-bis(3-methyl-4-hydroxyphenyl)-ethane, 1,2-bis(4-hydroxy-3,5-dimethyl phenyl)-1,2-diphenylethane, 1,2-bis(3-methyl-4-hydroxyphenyl)-1,2-diphenylethane, 1,2-bis(3-methyl-4-hydroxyphenyl)ethane, 2,2′-binaphthol, 2,2′biphenol, 2,2′-dihydroxy-4,4′-dimethoxybenzophenone, 2,2′-dihydroxy-4-methoxybenzophenone, 2,2′-dihydroxybenzophenone, 2,2-bis(3,5-dichloro-4-hydroxyphenyl)propane, 2,2-bis(3-bromo-4-hydroxyphenyl)propane, 2,2-bis(3-phenyl-4-hydroxyphenyl)propane, 2,2-bis(3-methyl-4-hydroxyphenyl)propane, 2,2-bis(3,5-dimethyl-4-hydroxyphenyl)propane, 1,1-bis(3,5-dimethyl-4-hydroxyphenyl)-1-phenylethane, 1,1-bis(3-chloro-4-hydroxyphenyl)-1-phenylethane, 1,1-bis(3-methyl-4-hydroxyphenyl)-1-phenylethane, 2,2-bis(4-hydroxy-3,5-dimethyl phenyl)-1-phenylpropane, 2,2-bis(4-hydroxy-3,5-dimethyl phenyl)hexane, 2,2-bis(4-hydroxy-3,5-dimethylphenyl)pentane, 2,2-bis(3-methyl-4-hydroxynaphthyl)propane, 2,2-bis(3-methyl-4-hydroxyphenyl)-1-phenylpropane, 2,2-bis(3-methyl-4-hydroxyphenyl)hexane, 2,2-bis(3-methyl-4-hydroxyphenyl)pentane, 2,2′-methylenebis(4-methylphenol), 2,2′-methylenebis[4-methyl-6-(1-methylcyclohexyl)phenol], 3,3′,5,5′-tetramethyl-4,4′-biphenol, 3,3′-dimethyl-4,4′-biphenol, bis(2-hydroxyphenyl)-methane, bis(4-hydroxy-2,6-dimethyl-3-methoxyphenyl)methane, bis(3,5-dimethyl-4-hydroxyphenyl)methane, bis(3-methyl-4-hydroxyphenyl)methane, bis-(4-hydroxy-3,5-dimethyl phenyl)-cyclohexylmethane, bis(4-hydroxy-3,5-dimethyl phenyl)phenylmethane, bis(3-methyl-4-hydroxyphenyl)cyclohexylmethane, bis(3-methyl-4-hydroxyphenyl)methane, bis(3,5-dimethyl-4-hydroxyphenyl)methane, bis(3-methyl-4-hydroxyphenyl)phenylmethane, 2,2′,3,3′,5,5′-hexamethyl-4,4′-biphenol, octafluoro-4,4′-biphenol, 2,3,3′,5,5′-pentamethyl-4,4′-biphenol, 1,1-bis(3,5-dibromo-4-hydroxyphenyl)cyclohexane 1,1-bis(3,5-dimethyl-4-hydroxyphenyl)cyclohexane, bis(3-methyl-4-hydroxyphenyl)cyclohexane tetrabromobiphenol, tetrabromobisphenol A, tetrabromobisphenol S, 2,2′-diallyl-4,4′-bisphenol A, 2,2′-diallyl-4,4′-bisphenol S, 3,3′,5,5′-tetramethyl-4,4′-bisphenol sulfide, 3,3′-dimethyl bisphenol sulfide, 3,3′,5,5′-tetramethyl-4,4′-bisphenol sulfone, and combinations thereof. In one embodiment, the dihydric phenol comprises 2,2-bis(3,5-dimethyl-4-hydroxyphenyl)propane, sometimes referred to as “tetramethyl bisphenol A”.

The polyhydric phenol may comprise more than two phenolic hydroxy groups. In one embodiment, the polyhydric phenol comprises 3 or 4 phenolic hydroxy groups. Suitable polyhydric phenols comprising three or more phenolic hydroxy groups include, for example, 1,1,1-tris(3,5-dimethyl-4-hydrxyphenyl)ethane 1,1,1-tris(3-methyl-4-hydroxyphenyl)ethane, 1,3,5-tris(3,5-dimethyl-4-hydroxyphenyl-1-keto)benzene, 1,3,5-tris(3,5-dimethyl-4hydroxyphenyl-1-isopropylidene)benzene, 2,2,4,4-tetrakis(3-methyl-4hydroxyphenyl)pentane, 2,2,4,4-tetrakis(3,5-dimethyl-4-hydroxyphenyl)pentane, 1,1,4,4-tetrakis(3-methyl-4-hydroxyphenyl)cyclohexane, 1,1,4,4-tetrakis(3,5-dimethyl-4-hydroxyphenyl)cyclohexane, 1,3,5-tris(3,5-dimethyl-4-hydroxyphenyl)benzene, 1,3,5-tris(3-methyl-4-hydroxyphenyl)benzene, 2,6-bis(2-hydroxy-5-methylbenzyl)-4-methyl phenol, 4,6-dimethyl-2,4,6-tris(4-hydroxy-3-methylphenyl)-2-heptene, 4,6-dimethyl-2,4,6-tris(4-hydroxy-3,5-dimethylphenyl)-2-heptene, 4,6-dimethyl-2,4,6-tris(4-hydroxy-3-methylphenyl)heptane, 4,6-dimethyl-2,4,6-tris(4-hydroxy-3-methylphenyl)heptane, 2,4-bis(4-hydroxy-3-methylphenylisopropyl)phenol, 2,4-bis(4-hydroxy-3,5-dimethylphenylisopropyl)phenol, tetrakis(4-hydroxy-3-methylphenyl)methane, tetrakis(4-hydroxy-3,5-dimethylphenyl)methane, tetrakis(4-[4-hydroxy-3-methylphenylisopropyl]-phenoxy)methane, tetrakis(4-[4-hydroxy-3,5-dimethylphenylisopropyl]-phenoxy)methane, and combinations thereof. In one embodiment, the polyhydric phenol comprises a dihydric phenol and a polyhydric phenol comprising 3 to about 8 phenolic hydroxy groups.

In one embodiment, the monohydric phenol and the polyhydric phenol are copolymerized in a mole ratio of about 3 to about 110. Within this range, the ratio may be at least about 5, or at least about 7. Also within this range, the ratio may be up to about 50, or up to about 25. Using such a ratio helps ensure that the target intrinsic viscosity is achieved.

The method comprises copolymerizing the monohydric phenol and the polyhydric phenol in an aromatic hydrocarbon solvent. Suitable aromatic hydrocarbon solvents include, for example, benzene, toluene, xylenes, and the like, and combinations thereof. In one embodiment, the aromatic hydrocarbon solvent comprises toluene. In addition to the aromatic hydrocarbon solvent, the solvent may, optionally, further comprise a C₃-C₈ aliphatic alcohol that is a poor solvent for the poly(arylene ether), such as, for example, n-propanol, isopropanol, n-butanol, t-butanol, n-pentanol, and the like, and combinations thereof. A preferred C₃-C₈ aliphatic alcohol is n-butanol. The solvent may further comprise, in addition to a C₆-C₁₈ aromatic hydrocarbon and a C₃-C₈ aliphatic alcohol, methanol or ethanol, which act as an anti-solvent for the poly(arylene ether). The C₆-C₁₈ aromatic hydrocarbon, the C₃-C₈ aliphatic alcohol, and the methanol or ethanol may be combined in a wide range of proportions, but it may be preferred that the solvent comprise at least about 50 weight percent of the C₆-C₁₈ aromatic hydrocarbon.

Although there is no particular limit on the concentrations of the monohydric phenol and the polyhydric phenol in the aromatic hydrocarbon solvent, it is preferred to achieve a balance between the increased efficiency of higher monomer concentrations and the easy-to-handle solution viscosities associated with lower monomer concentrations. In one embodiment, the monohydric phenol, the polyhydric phenol, and the solvent are used in amounts such that the ratio of the total weight of the monohydric phenol and the polyhydric phenol to the total weight of the monohydric phenol, the polyhydric phenol, and the solvent is about 0.1:1 to about 0.5:1. Within this range, the ratio maybe at least about 0.2:1, or at least about 0.23:1, or at least about 0.26:1. Also within this range, the ratio may be up to about 0.4:1, or up to about 0.37:1, or up to about 0.34:1.

The method comprises oxidatively copolymerizing the monohydric phenol and the polyhydric phenol in an aromatic hydrocarbon solvent in the presence of a catalyst comprising a metal ion and a nitrogen-containing ligand. In one embodiment, the catalyst metal ion is selected from ions of copper, manganese, cobalt, iron, and combinations thereof. In one embodiment, the catalyst metal ion comprises copper ion. In one embodiment, the concentration of the catalyst metal ion may be such that the ratio of total moles of monomer (i.e., moles of monohydric phenol plus moles of polyhydric phenol) to moles of catalyst metal ion may be about 100:1 to about 10,000:1. Within this range, the ratio may be at least about 300:1, or at least about 600:1. Also within this range, the ratio may be up to about 6,000:1, or up to about 3,000:1.

In addition to the metal ion, the copolymerization catalyst comprises a nitrogen-containing ligand. The nitrogen-containing ligand may include, for example, alkylenediamine ligands, primary monoamines, secondary monoamines, tertiary monoamines, aminoalcohols, oximes, oxines, cyanide, and the like, and combinations thereof.

Suitable alkylenediamine ligands include those having the formula
(R^{b})₂N—R^{a}—N(R^{b})₂
wherein R^{a} is a substituted or unsubstituted divalent residue wherein two or three aliphatic carbon atoms form the closest link between the two diamine nitrogen atoms; and each R^{b} is independently hydrogen or C₁-C₈ alkyl. Preferred alkylenediamine ligands include those in which R^{a} is ethylene (—CH₂CH₂—) or trimethylene (—CH₂CH₂CH₂—), and each R^{b} is independently hydrogen, isopropyl, or a C₄-C₈ alpha-tertiary alkyl group. Highly preferred alkylenediamine ligands include N,N′-di-t-butylethylenediamine and N,N,N′,N′-tetramethyl-1,3-diaminopropane.

Suitable primary monoamines include C₃-C₁₂ primary alkylamines, such as, for example, n-propylamine, i-propylamine, n-butylamine, sec-butylamine, t-butylamine, n-penylamine, n-hexylamine, cyclohexylamine, combinations comprising at least one of the foregoing primary monoamines, and the like. A highly preferred primary monoamine is n-butylamine.

Suitable secondary monoamines include secondary monoamines having the structure (R^{c})(R^{d})NH, wherein R^{c} and R^{d} are each independently a C₁-C₁₁ alkyl group, with the proviso that R^{c} and R^{d} collectively have a total of four to twelve carbon atoms. Examples of secondary monoamines include di-n-propylamine, n-propyl-n-butylamine, di-n-butylamine, d-t-butylamine, n-butyl-n-penylamine, di-n-hexylamine, and the like, with di-n-butylamine being preferred.

Suitable tertiary monoamines include tertiary monoamines having the structure (R^{e})(R^{f})(R^{g})N, wherein R^{e} and R^{f} and R^{g} are each independently a C₁-C₁₆ alkyl group, with the proviso that R^{e} and R^{f} and R^{g} collectively have a total of four to eighteen carbon atoms. Examples of tertiary monoamines include triethylamine, tri-n-propylamine, tri-n-butylamine, dimethyl-n-butylamine, dimethyl-n-penylamine, diethyl-n-butylamine, tricyclohexylamine, and the like. In addition, cyclic tertiary amines, such as pyridine, alpha-collidine, gamma-picoline, and the like, can be used. Highly preferred tertiary monoamines include dimethyl-n-butylamine. Additional primary, secondary, and tertiary amines are described in U.S. Pat. Nos. 3,306,874 and 3,306,875 to Hay.

Suitable aminoalcohols include C₄-C₁₂ aminoalcohols having one nitrogen atom and an alcohol oxygen, wherein at least two carbon atoms separate the amino nitrogen and the alcohol oxygen. Examples of aminoalcohols include N,N-diethylethanolamine, 4-butanolamine, N-methyl-4-butanolamine, diethanolamine, triethanolamine, N-phenyl-ethanolamine, and the like, and combinations comprising at least one of the foregoing aminoalcohols. Highly preferred aminoalcohols include triethanolamine and N-phenyl-ethanolamine.

Suitable oximes include benzoin oxime (2-Hydroxy-2-phenylacetophenone oxime), 2-phenyl-2-hydroxybutan-3-one oxime, 2-salicyl-aldoxime, and combinations thereof.

Suitable oxines include those having the formula 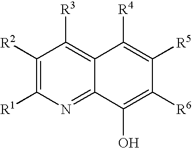
wherein R¹-R⁶ are each independently hydrogen, halogen, hydroxyl, nitro, amino, C₁-C₆ alkyl, or C₁-C₆ alkoxyl. Examples of oxines include oxine, 5-methyloxine, 5-hydroxyoxine, 5-nitroxine, 5-aminoxine, 2-methyloxine, and the like, and combinations comprising at least one of the foregoing oxines. Highly preferred oxines include oxine and 5-methyloxine.

The alkylenediamine ligands, primary monoamines, secondary monoamines, aminoalcohols, and oxines, when present, may be used at about 0.01 to about 25 moles per 100 moles of monohydric phenol. The tertiary monoamines may be used at about 0.1 to about 1,500 moles per 100 moles of monohydric phenol.

In addition to the metal ion and the nitrogen-containing ligand, the catalyst may, optionally, further include a halide ion such as chloride, bromide, or iodide. When employed, halide ions may be supplied to the reaction mixture in the form of an alkali metal salt or an alkaline earth metal salt at a concentration of about 0.1 mole to about 150 moles per 100 moles total of phenolic monomer.

In one embodiment, the nitrogen-containing ligand is selected from dibutylamine, dimethylbutylamine, N,N′-di-t-butylethylenediamine, pyridine, and combinations thereof. In one embodiment, the complex metal catalyst comprises copper ion, a secondary alkylenediamine ligand, a secondary monoamine, and a tertiary monoamine. In one embodiment, the complex metal catalyst comprises copper ion, N,N′-di-t-butylethylenediamine, di-n-butylamine, and dimethyl-n-butylamine.

Various modes of addition of the monohydric phenol and the polyhydric phenol to the copolymerization mixture are possible. In one embodiment, all of the monohydric phenol and all of the polyhydric phenol are added to the reactor before initiating polymerization. In another embodiment, all of the polyhydric phenol is added to the reactor before initiating polymerization, and a portion of the monohydric phenol is added to the reaction before initiating polymerization, such that the molar ratio of monohydric phenol to polyhydric phenol is about 0.1 to about 30 before initiating polymerization. Within this range, the ratio may be at least about 0.5, or at least about 1. Also within this range, the ratio may be up to about 20, or up to about 10.

In another embodiment, a portion of the monohydric phenol and a portion of the polyhydric phenol are added to the reactor before initiating polymerization, and the remainder of the monohydric phenol and the remainder of the polyhydric phenol are added to the reactor after initiating polymerization.

In one embodiment, during copolymerization, the reaction temperature may be maintained at about 20 to about 80° C. Within this range, the reaction temperature may be at least about 30° C., or at least about 40° C. Also within this range, the reaction temperature may be up to about 70° C., or up to about 60° C. Different temperatures may be used at different stages of the reaction.

The polymerization reaction time will depend on factors including the identities of the monohydric and polyhydric phenol, the solvent, the total monomer concentration, the catalyst type and concentration, and the oxygen concentration. In one embodiment, polymerization reaction times are about 0.5 to about 5 hours.

In one embodiment, during copolymerization, an oxygen flow of about 0.1 to about 3 moles O₂ per hour per total moles of monohydric phenol and polyhydric phenol may be maintained. Within this range, the oxygen flow may be at least about 0.3 moles O₂ per hour per total moles of monohydric phenol and polyhydric phenol, or at least about 0.5 moles O₂ per hour per total moles of monohydric phenol and polyhydric phenol. Also within this range, the oxygen flow may be up to about 2 moles O₂ per hour per total moles of monohydric phenol and polyhydric phenol, or up to about 1 moles O₂ per hour per total moles of monohydric phenol and polyhydric phenol.

In one embodiment, the copolymerization catalyst may be present in a concentration such that the catalyst metal ion is present at a concentration of about 0.0001 to about 0.01 moles per total moles of monohydric phenol and polyhydric phenol. Within this range, the catalyst metal ion concentration may be at least about 0.0002 moles per total moles of monohydric phenol and polyhydric phenol, or at least about 0.0005 moles per total moles of monohydric phenol and polyhydric phenol. Also within this range, the catalyst metal ion concentration may be up to about 0.005 moles per total moles of monohydric phenol and polyhydric phenol, or up to about 0.002 moles per total moles of monohydric phenol and polyhydric phenol. The catalyst amount may also be specified in terms of the weight ratio of total catalyst components to total monomer. Thus, in one embodiment, the ratio of total moles of catalyst metal ion, nitrogen-containing ligand, and halide ion to total moles of monohydric phenol and polyhydric phenol is about 0.005 to about 0.5.

In one embodiment, the polyfunctional poly(arylene ether) has an intrinsic viscosity of about 0.04 to about 0.3 deciliter per gram at 25° C. in chloroform. Within this range, the intrinsic viscosity may be at least about 0.06 deciliter per gram, or at least about 0.09 deciliter per gram. Also within this range, the intrinsic viscosity may be up to about 0.25 deciliter per gram, or up to about 0.20 deciliter per gram, or up to about 0.15 deciliter per gram, or up to about 0.12 deciliter per gram.

The method may be run on any scale, ranging from laboratory scale to commercial production scale. In one embodiment, method may be run on a batch scale corresponding to about 70 to about 80,000 pounds of the polyfunctional poly(arylene ether).

There is no particular limit on the type of chelating agent used, as long is it is effective to sequester the catalyst metal ion at the specified concentration. In one embodiment, the chelating agent is selected from polyalkylenepolyamine polycarboxylic acids, aminopolycarboxylic acids, aminocarboxylic acids, polycarboxylic acids, alkali metal salts of the foregoing acids, alkaline earth metal salts of the foregoing acids, mixed alkali metal-alkaline earth metal salts of the foregoing acids, and combinations thereof. In one embodiment, the chelating agent is selected from nitrilotriacetic acid, ethylenediaminetetraacetic acid, alkali metal salts of the foregoing acids, alkaline earth metal salts of the foregoing acids, mixed alkali metal-alkaline earth metal salts of the foregoing acids, and mixtures thereof. In one embodiment, the chelating agent comprises nitrilotriacetic acid or an alkali metal salt of nitrilotriacetic acid.

The chelating agent and metal ion are present in a molar ratio of about 1.0 to about 1.5. Within this range, the molar ratio may be at least about 1.05, or at least about 1.1, or at least about 1.15. Also within this range, the molar ratio may be up to about 1.4, or up to about 1.3.

In one embodiment, the polyfunctional poly(arylene ether) solution may be contacted with the aqueous solution of a chelating agent is conducted at a temperature of about 30 to about 90° C. Within this range, the temperature may be at least about 50° C., or at least about 60° C., or at least about 65° C., or at least about 70° C. Also within this range, the temperature may be up to about 85° C., or up to about 80° C.

The present inventors have determined that formation of a dispersion during the chelation step may be minimized if the ratio of the polyfunctional poly(arylene ether) solution density to the aqueous solution density is maintained at about 0.6 to about 1.0. Within this range, the ratio may be at least about 0.7, or at least about 0.9. Another way to minimize dispersion formation is to maintain a polyfunctional poly(arylene ether) solution viscosity of about 0.5 to about 3,000 centipoise. Within this range, the viscosity may be at least about 5 centipoise, or at least about 10 centipoise. Also within this range, the viscosity may be up to about 2,000 centipoise, or up to about 500 centipoise. Another way to minimize dispersion formation is to maintain a ratio of the polyfunctional poly(arylene ether) solution viscosity to the aqueous solution viscosity of about 0.5 to about 3,000. Within this range, the ratio may be at least about 5, or at least about 10. Also within this range, the ratio may be up to about 2,000, or up to about 500.

Yet another way to minimize dispersion formation is to mix with the lowest energy during the copolymerization and chelation steps. Thus, in one embodiment, oxidatively copolymerizing the monohydric phenol and the polyhydric phenol comprises agitating with a mixing energy of about 10 to about 150 kilojoules per kilogram total of the monohydric phenol, the polyhydric phenol, the solvent, and the catalyst. Within this range, the mixing energy may be at least about 30 kilojoules per kilogram, or at least 50 kilojoules per kilogram. Also within this range, the mixing energy may be up to about 130 kilojoules per kilogram, or up to 110 kilojoules per kilogram. In another embodiment, contacting the polyfunctional poly(arylene ether) solution with the aqueous chelating agent solution comprises agitating the polyfunctional poly(arylene ether) solution with the aqueous solution with a mixing energy of about 0.5 to about 25 kilojoules per kilogram total of the polyfunctional poly(arylene ether) solution and the aqueous solution. Within this range, the mixing energy may be at least about 1 kilojoule per kilogram, or at least 1.5 kilojoules per kilogram. Also within this range, the mixing energy may be up to about 20 kilojoules per kilogram, or up to 15 kilojoules per kilogram.

While some agitation in the chelation step is necessary to effectively conduct that step, it is possible to select agitation conditions that minimize dispersion formation. In one embodiment, contacting the polyfunctional poly(arylene ether) solution with the aqueous chelating agent solution comprises agitating the polyfunctional poly(arylene ether) solution with the aqueous solution for about 5 to about 120 minutes. Within this range, the agitation time may be at least about 15 minutes, or at least about 30 minutes. Also within this range, the agitation time may be up about 90 minutes, or up to about 60 minutes.

Chelation and separation can be improved by including a period of agitation-less contact of the polyfunctional poly(arylene ether) solution and the aqueous chelating agent solution. Thus, in one embodiment, contacting the polyfunctional poly(arylene ether) solution with an aqueous solution of a chelating agent comprises agitating the polyfunctional poly(arylene ether) solution with the aqueous solution, and subsequently leaving the polyfunctional poly(arylene ether) solution and the aqueous solution in contact without agitation for about 1 to about 30 hours. Within this range, the period of agitation-less contact may be at least about 4 hours, or at least about 8 hours. Also within this range, the period of agitation-less contact may be up to about 20 hours.

Yet other ways to minimize the chance of dispersion formation during the chelation step include adding solvent to the polyfunctional poly(arylene ether) solution prior to contacting the polyfunctional poly(arylene ether) solution with the chelating agent aqueous solution; adding water to the mixture of the polyfunctional poly(arylene ether) solution and the chelating agent aqueous solution; using a chelating agent concentration of about 0.01 to about 0.1 weight percent based on the total weight of the polyfunctional poly(arylene ether) solution and the aqueous solution of the chelating agent; and using a chelating agent concentration of about 0.5 to about 40 weight percent based on the total weight of the aqueous solution of the chelating agent. In one embodiment, contacting the polyfunctional poly(arylene ether) solution with an aqueous solution of a chelating agent comprises using the chelating agent in an amount of about 0.5 to about 50 weight percent based on the total weight of the aqueous solution of the chelating agent.

There is no particular limit on the method used to isolate the poly(arylene ether) once the chelation step is completed. For example, the poly(arylene ether) solution and the aqueous chelating agent solution may be separated with a liquid-liquid centrifuge. Once this separation has been effected, the polyfunctional poly(arylene ether) may be isolated from the poly(arylene ether) solution using a total isolation method. Suitable total isolation methods include, for example, devolatilizing extrusion, spray drying, wiped film evaporation, flake evaporation, and combinations of the foregoing methods. Devolatilizing extrusion is presently preferred, and the specific techniques of U.S. Pat. No. 6,211,327 B1 to Braat et al. may be employed. The isolated polyfunctional poly(arylene ether) may have an intrinsic viscosity of about 0.04 to about 0.3 deciliter per gram at 25° C. in chloroform. Within this range, the intrinsic viscosity may be at least about 0.06 deciliter per gram, or at least about 0.09 deciliter per gram. Also within this range, the intrinsic viscosity may be up to about 0.25 deciliter per gram, or up to about 0.20 deciliter per gram, or up to about 0.15 deciliter per gram, or up to about 0.12 deciliter per gram.

Even though it utilizes low levels of chelating agent, the method is effective to reduce the concentration of catalyst metal in the isolated polyfunctional poly(arylene ether). Thus, in one embodiment, the isolated polyfunctional poly(arylene ether) has a concentration of catalyst metal of about 2 to about 5 parts per million by weight.

One embodiment is a method of preparing a bifunctional poly(arylene ether) resin, comprising: oxidatively copolymerizing a monohydric phenol and an alkylidenediphenol in an aromatic hydrocarbon solvent in the presence of a catalyst comprising a metal ion and a nitrogen-containing ligand to form a solution comprising a bifunctional poly(arylene ether) having an intrinsic viscosity of about 0.04 to about 0.20 deciliter per gram at 25° C. in chloroform; and contacting the bifunctional poly(arylene ether) solution with an aqueous solution of a chelating agent to extract the metal ion from the solution; wherein the chelating agent and metal ion are present in a molar ratio of about 1.0 to about 1.4; wherein the monohydric phenol is selected from 2,6-dimethylphenol, 2,3,6-trimethylphenol, and mixtures thereof; wherein the alkylidenediphenol has the structure 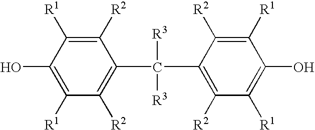
wherein each occurrence of R¹ is methyl; each occurrence of R² is independently hydrogen or methyl; and each occurrence of R³ is independently hydrogen or methyl; wherein the aromatic hydrocarbon solvent is selected from benzene, toluene, xylenes, and combinations thereof; wherein the chelating agent is selected from nitrilotriacetic acid, ethylenediaminetetraacetic acid, alkali metal salts of the foregoing acids, alkaline earth metal salts of the foregoing acids, mixed alkali metal-alkaline earth metal salts of the foregoing acids, and mixtures thereof; and wherein said contacting the bifunctional poly(arylene ether) solution with an aqueous solution of a chelating agent is conducted with agitation at about 40 to about 85° C., for about 15 to about 120 minutes, with a mixing energy of about 5 to about 20 kilojoules per kilogram total of the bifunctional poly(arylene ether) solution and the aqueous solution.

Another embodiment is a method of preparing a bifunctional poly(arylene ether) resin, comprising: oxidatively copolymerizing 2,6-dimethyphenol and 2,2-bis(3,5-dimethyl-4-hydroxyphenyl)propane in toluene in the presence of a catalyst comprising copper ion and a nitrogen-containing ligand to form a solution comprising a bifunctional poly(arylene ether) having an intrinsic viscosity of about 0.04 to about 0.15 deciliter per gram at 25° C. in chloroform; and contacting the bifunctional poly(arylene ether) solution with an aqueous solution of nitrilotriacetic acid trisodium salt to extract the copper ion from the solution; wherein the nitrilotriacetic acid trisodium salt and copper ion are present in a molar ratio of about 1.1 to about 1.4; wherein the 2,6-dimethyphenol, the 2,2-bis(3,5-dimethyl-4-hydroxyphenyl)propane, and the toluene are used in amounts such that the ratio of the total weight of the 2,6-dimethyphenol and the 2,2-bis(3,5-dimethyl-4-hydroxyphenyl)propane to the total weight of the 2,6-dimethyphenol, the 2,2-bis(3,5-dimethyl-4-hydroxyphenyl)propane, and the toluene is about 0.26:1 to about 0.34:1; wherein the nitrogen-containing ligand comprises dibutylamine, dimethylbutylamine, and N,N′-di-t-butylethylenediamine; wherein said contacting the bifunctional poly(arylene ether) solution with an aqueous solution of a chelating agent is conducted with agitation at about 50 to about 80° C., for about 15 to about 120 minutes, with a mixing energy of about 5 to about 15 kilojoules per kilogram total of the bifunctional poly(arylene ether) solution and the aqueous solution; wherein said contacting the bifunctional poly(arylene ether) solution with an aqueous solution of nitrilotriacetic acid trisodium salt comprises maintaining a ratio of a bifunctional poly(arylene ether) solution viscosity to an aqueous solution viscosity of about 5 to about 500; and wherein said contacting the bifunctional poly(arylene ether) solution with an aqueous solution of nitrilotriacetic acid trisodium salt comprises maintaining a ratio of a bifunctional poly(arylene ether) solution density to an aqueous solution density of about 0.8 to about 1.0 gram per milliliter.

The invention is further illustrated by the following non-limiting examples.

### EXAMPLES 1-4

Examples 1-4 represent preparations of bifunctional poly(arylene ether)s having intrinsic viscosities of about 0.12, about 0.09, and about 0.06 deciliter per gram. These examples also illustrate the effect of chelating agent concentration on the separation or emulsification of the combined poly(arylene ether) solution and the aqueous chelating agent solution.

For each example, a monomer solution was prepared using the amounts of 2,6-xylenol (2,6-dimethylphenol), 2,2-bis(3,5-dimethyl-4-hydroxyphenyl)propane (“tetramethylbisphenol A” or “TMBPA”), and toluene specified in Table 1. The monomer solution was prepared by adding toluene and 2,6-xylenol to a drum, heating to 60° C., and then adding TMBPA and stirring until all the TMBPA had dissolved. After the monomer solution was prepared, the reactor was purged with nitrogen and charged with additional toluene (54.34 kg). The monomer solution was then added to the reactor, followed by catalyst components dibutylamine (“DBA”), dimethylbutylamine (“DMBA”), a previously blended amine mixture of N,N′-dibutylethylenediamine (“DBEDA”) and didecyl dimethyl ammonium chloride (“PTA”) and toluene, and a previously blended mixture of cuprous oxide (“Cu₂O”) and aqueous hydrogen bromide (“HBr”). At reaction time zero, the oxygen flow rate was initiated and ramped up to 3.40 standard cubic meters per hour (SCMH) in 0.28 SCMH increments, making sure that the headspace oxygen concentration never exceeded 13%. After 65 minutes, the reaction mixture was heated so as to attain a temperature of 49° C. at 80 minutes. After the “end of exotherm time” listed in Table 1, the oxygen flow was decreased to maintain a headspace oxygen concentration below 20%. About 20 to 30 minutes after decreasing the oxygen flow, a sample of the reaction mixture was removed to analyze intrinsic viscosity, percent solids, hydroxyl content, residual 2,6-xylenol, and residual TMBPA. The reaction temperature was increased to 60° C., and the reaction mixture was pumped to a different tank for copper removal and thermal equilibration. A solution having the Table 1 amount of trisodium nitrilotriacetate acid (“Na₃NTA”) in water was prepared and added with agitation to the reaction mixture, the temperature of which had been increased to 74° C. After two hours, a small sample was removed for visual inspection. The sample from Example 1 had emulsified. Samples from Examples 2-4 initially had clearly separated aqueous and organic layers. (For Example 1, additional portions of Na₃NTA solution and toluene were added simultaneously and the mixture was agitated at 74° C. for 15 minutes. For Example 2, additional Na₃NTA solution was added and the mixture was agitated at 74° C. remove decimal for 15 minutes. For Example 4, two additional portions of Na₃NTA solution were added, with emulsification occurring after the third addition of Na₃NTA solution; addition of more toluene resulted in layer separation.) The mixture was then left at 74° C. for about 12 hours without any agitation. The dense (aqueous) phase was drawn off, and a small sample of the light phase was removed for analysis of copper content. All four examples exhibited copper levels less than 3.5 parts per million. (When the copper content exceeds 5 parts per million by weight, the NTA addition and equilibration step may be repeated with 15 minutes agitation and 2 hours without agitation.) The light (organic, poly(arylene ether)-containing) phase was transferred to a drum.

Polyfunctional poly(arylene ether) solids were isolated by a total isolation procedure that consisted of solvent evaporation on a rotary evaporator and oven drying. The “functionality” (i.e., average number of hydroxyl groups per poly(arylene ether) chain) was determined by proton nuclear magnetic resonance spectroscopy (¹H NMR).

These examples demonstrate that the present method is useful for preparing a low intrinsic viscosity, polyfunctional poly(arylene ether) resin having a low level of residual catalyst metal while avoiding dispersion formation during chelation of the catalyst metal.

TABLE 1

| Setting | Ex. 1 | Ex. 2 | Ex. 3 | Ex. 4 |
|---|---|---|---|---|
| Monomer solution to prepare and | | | | |
| add to reactor: | | | | |
| 2,6-Xylenol | 42.3 kg | 41.7 kg | 38.2 kg | 38.2 kg |
| TMBPA | 5.03 kg | 8.53 kg | 12.07 kg | 12.07 kg |
| Toluene | 50.26 kg | 50.26 kg | 50.26 kg | 50.26 kg |
| Initial toluene to add to reactor | 54.34 kg | 54.34 kg | 54.34 kg | 54.34 kg |
| DBA to add to reactor | 503.8 g | 503.8 | 503.8 | 503.8 |
| DMBA to add to reactor | 1175.6 g | 1175.6 g | 1175.6 g | 1175.6 g |
| Diamine mix to add to reactor | 264.5 g | 264.5 g | 264.5 g | 264.5 g |
| (30% DBEDA, 15% PTA, 55% | | | | |
| Toluene) | | | | |
| Catalyst to add to reactor: | | | | |
| HBr, 48% solution | 353.3 g | 353.3 g | 353.3 g | 353.3 g |
| Cu₂O | 24.6 g | 24.6 g | 24.6 g | 24.6 g |
| Nitrogen flow | 3.40 | 4.25 | 4.25 | 4.25 |
| | SCMH | SCMH | SCMH | SCMH |
| Reactor temperature | 30° C. | 30° C. | 42° C. | 42° C. |
| Reactor agitator speed | 500 rpm | 500 rpm | 500 rpm | 500 rpm |
| End of exotherm time | 160 min | 101 min | 96 min | 96 min |
| % Oxygen in overhead during | 13% | 13% | 13.5% | 14% |
| exotherm | | | | |
| % Oxygen in overhead after | 21% | 20% | 18% | 19% |
| exotherm | | | | |
| Oxygen flow after exotherm | 0.42 | 0.42 | 0.42 | 0.42 |
| | SCMH | SCMH | SCMH | SCMH |
| IV on sample out of the reactor | 0.117 dl/g | 0.075 dl/g | 0.066 dl/g | 0.065 dl/g |
| % solids in reactor | 29.4% | 29.3% | 29.6% | 29.9% |
| First NTA addition (kg of 40% | 2.05 kg | 0.318 kg | 0.318 kg | 0.318 kg |
| Na₃NTA solution) | | | | |
| Visual confirmation of heavy | Emulsified | Separated | Separated | Separated |
| phase | | | | |
| Copper content | >20 ppm | 3 ppm | | >20 ppm |
| Second NTA addition (kg of | 1.8 kg | 0.32 kg | — | 0.32 kg |
| 40% Na₃NTA solution) | | | | |
| Visual confirmation of heavy | — | Separated | — | Separated |
| phase | | | | |
| Copper content | — | 2.9 ppm | — | 7 ppm |
| Third NTA addition (kg of 40% | — | — | — | 0.32 kg |
| Na₃NTA solution) | | | | |
| Visual confirmation of heavy | — | — | — | Emulsified |
| phase | | | | |
| Copper content | | | | 5.8 ppm |
| Additional toluene added | ˜360 kg | — | — | ˜450 kg |
| Visual confirmation of heavy | Separated | — | — | Separated |
| phase | | | | |
| Total moles NTA/moles Cu | 6.98 | 2.874 | 1.437 | 4.311 |
| Final copper content | 1.1 ppm | 2.9 ppm | 2.8 ppm | 3.5 ppm |
| Final product IV | 0.116 dL/g | 0.087 dL/g | 0.067 dL/g | 0.063 dL/g |
| Functionality (by ¹H NMR) | 1.9 | 1.91 | 1.92 | 1.91 |

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

All cited patents, patent applications, and other references are incorporated herein by reference in their entirety.

All ranges disclosed herein are inclusive of the endpoints, and the endpoints are combinable with each other.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

1. A method of preparing a poly(arylene ether) resin, comprising:
oxidatively copolymerizing a monohydric phenol and a polyhydric phenol in an aromatic hydrocarbon solvent in the presence of a catalyst comprising a metal ion and a nitrogen-containing ligand to form a solution comprising a polyfunctional poly(arylene ether) having an intrinsic viscosity of about 0.04 to about 0.3 deciliter per gram at 25° C. in chloroform; and
contacting the polyfunctional poly(arylene ether) solution with an aqueous solution of a chelating agent to extract the metal ion from the solution; wherein the chelating agent and metal ion are present in a molar ratio of about 1.0 to about 1.5.

2. The method of claim 1, wherein the monohydric phenol has the structure 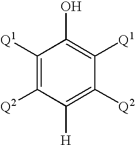
wherein each occurrence of Q¹ is independently halogen, primary or secondary C₁-C₁₂ alkyl, C₂-C₁₂ alkenyl, C₃-C₁₂ alkenylalkyl, C₂-C₁₂ alkynyl, C₃-C₁₂ alkynylalkyl, C₁-C₁₂ aminoalkyl, C₁-C₁₂ hydroxyalkyl, C₆-C₁₂ aryl, C₁-C₁₂ haloalkyl, C₁-C₁₂ hydrocarbonoxy, C₁-C₁₂ halohydrocarbonoxy wherein at least two carbon atoms separate the halogen and oxygen atoms; and wherein each occurrence of Q² is independently hydrogen, halogen, primary or secondary C₁-C₁₂ alkyl, C₂-C₁₂ alkenyl, C₃-C₁₂ alkenylalkyl, C₂-C₁₂ alkynyl, C₃-C₁₂ alkynylalkyl, C₁-C₁₂ aminoalkyl, C₁-C₁₂ hydroxyalkyl, C₆-C₁₂ aryl, C₁-C₁₂ haloalkyl, C₁-C₁₂ hydrocarbonoxy, C₁-C₁₂ halohydrocarbonoxy wherein at least two carbon atoms separate the halogen and oxygen atoms.

3. The method of claim 1, wherein the monohydric phenol is selected from 2,6-dimethylphenol, 2,3,6-trimethylphenol, and mixtures thereof.

4. The method of claim 1, wherein the polyhydric phenol comprises 2 to about 8 phenolic hydroxy groups.

5. The method of claim 1, wherein the polyhydric phenol is a dihydric phenol having the structure 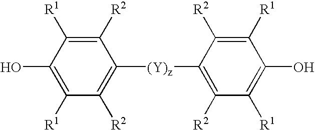
wherein each occurrence of R¹ and R² is independently hydrogen, halogen, primary or secondary C₁-C₁₂ alkyl, C₁-C₁₂ alkenyl, C₁-C₁₂ alkynyl, C₁-C₁₂ aminoalkyl, C₁-C₁₂ hydroxyalkyl, C₆-C₁₂ aryl (including phenyl), C₁-C₁₂ haloalkyl, C₁-C₁₂ hydrocarbonoxy, C₁-C₁₂ halohydrocarbonoxy wherein at least two carbon atoms separate the halogen and oxygen atoms; Z is 0 or 1; and Y is selected from 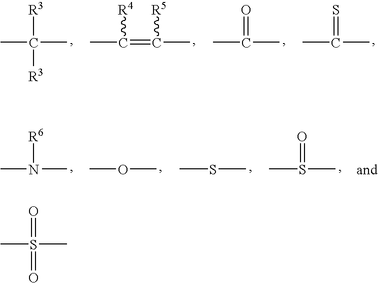
wherein each occurrence of R³—R⁶ is independently hydrogen or C₁-C₁₂ hydrocarbyl.

6. The method of claim 5, wherein each occurrence of R¹ is methyl, each occurrence of R² and R³ is independently hydrogen or methyl.

7. The method of claim 1, wherein the polyhydric phenol is selected from 1,1-bis(3,5-dimethyl-4-hydroxyphenyl)ethane, 1,1-bis(3-chloro-4-hydroxyphenyl)ethane, 1,1-bis(3-methyl-4-hydroxyphenyl)-ethane, 1,2-bis(4-hydroxy-3,5-dimethylphenyl)-1,2-diphenylethane, 1,2-bis(3-methyl-4-hydroxyphenyl)-1,2-diphenylethane, 1,2-bis(3-methyl-4-hydroxyphenyl)ethane, 2,2′-binaphthol, 2,2′biphenol, 2,2′-dihydroxy-4,4′-dimethoxybenzophenone, 2,2′-dihydroxy-4-methoxybenzophenone, 2,2′-dihydroxybenzophenone, 2,2-bis(3,5-dichloro-4-hydroxyphenyl)propane, 2,2-bis(3-bromo-4-hydroxyphenyl)propane, 2,2-bis(3-phenyl-4-hydroxyphenyl)propane, 2,2-bis(3-methyl-4-hydroxyphenyl)propane, 2,2-bis(3,5-dimethyl-4-hydroxyphenyl)propane, 1,1-bis(3,5-dimethyl-4-hydroxyphenyl)-1-phenylethane, 1,1-bis(3-chloro-4-hydroxyphenyl)-1-phenylethane, 1,1-bis(3-methyl-4-hydroxyphenyl)-1-phenylethane, 2,2-bis(4-hydroxy-3,5-dimethyl phenyl)-1-phenylpropane, 2,2-bis(4-hydroxy-3,5-dimethyl phenyl)hexane, 2,2-bis(4-hydroxy-3,5-dimethylphenyl)pentane, 2,2-bis(3-methyl-4-hydroxynaphthyl)propane, 2,2-bis(3-methyl-4-hydroxyphenyl)-1-phenylpropane, 2,2-bis(3-methyl-4-hydroxyphenyl)hexane, 2,2-bis(3-methyl-4-hydroxyphenyl)pentane, 2,2′-methylenebis(4-methylphenol), 2,2′-methylenebis[4-methyl-6-(1-methylcyclohexyl)phenol], 3,3′,5,5′-tetramethyl-4,4′-biphenol, 3,3′-dimethyl-4,4′-biphenol, bis(2-hydroxyphenyl)-methane, bis(4-hydroxy-2,6-dimethyl-3-methoxyphenyl)methane, bis(3,5-dimethyl-4-hydroxyphenyl)methane, bis(3-methyl-4-hydroxyphenyl)methane, bis-(4-hydroxy-3,5-dimethyl phenyl)-cyclohexylmethane, bis(4-hydroxy-3,5-dimethyl phenyl)phenylmethane, bis(3-methyl-4-hydroxyphenyl)cyclohexylmethane, bis(3-methyl-4-hydroxyphenyl)methane, bis(3,5-dimethyl-4-hydroxyphenyl)methane, bis(3-methyl-4-hydroxyphenyl)phenylmethane, 2,2′,3,3′,5,5′-hexamethyl-4,4′-biphenol, octafluoro-4,4′-biphenol, 2,3,3′,5,5′-pentamethyl-4,4′-biphenol, 1,1-bis(3,5-dibromo-4-hydroxyphenyl)cyclohexane 1,1-bis(3,5-dimethyl-4-hydroxyphenyl)cyclohexane, bis(3-methyl-4-hydroxyphenyl)cyclohexane, tetrabromobiphenol, tetrabromobisphenol A, tetrabromobisphenol S, 2,2′-diallyl-4,4′-bisphenol A, 2,2′-diallyl-4,4′-bisphenol S, 3,3′,5,5′-tetramethyl-4,4′-bisphenol sulfide, 3,3′-dimethyl bisphenol sulfide, 3,3′,5,5′-tetramethyl-4,4′-bisphenol sulfone and combinations thereof.

8. The method of claim 1, wherein the polyhydric phenol comprises 2,2-bis(3,5-dimethyl-4-hydroxyphenyl)propane.

9. The method of claim 1, wherein the polyhydric phenol comprises 3 or 4 phenolic hydroxy groups.

10. The method of claim 9, wherein the polyhydric phenol is selected from 1,1,1-tris(3,5-dimethyl-4-hydrxyphenyl)ethane 1,1,1-tris(3-methyl-4-hydroxyphenyl)ethane, 1,3,5-tris(3,5-dimethyl-4-hydroxyphenyl-1-keto)benzene, 1,3,5-tris(3,5-dimethyl-4-hydroxyphenyl-1-isopropylidene)benzene, 2,2,4,4-tetrakis(3-methyl-4hydroxyphenyl)pentane, 2,2,4,4-tetrakis(3,5-dimethyl-4-hydroxyphenyl)pentane, 1,1,4,4-tetrakis(3-methyl-4-hydroxyphenyl)cyclohexane, 1,1,4,4-tetrakis(3,5-dimethyl-4-hydroxyphenyl)cyclohexane, 1,3,5-tris(3,5-dimethyl-4-hydroxyphenyl)benzene, 1,3,5-tris(3-methyl-4-hydroxyphenyl)benzene, 2,6-bis(2-hydroxy-5-methylbenzyl)-4-methyl phenol, 4,6-dimethyl-2,4,6-tris(4-hydroxy-3-methylphenyl)-2-heptene, 4,6-dimethyl-2,4,6-tris(4-hydroxy-3,5-dimethylphenyl)-2-heptene, 4,6-dimethyl-2,4,6-tris(4-hydroxy-3-methylphenyl)heptane, 4,6-dimethyl-2,4,6-tris(4-hydroxy-3-methylphenyl)heptane, 2,4-bis(4-hydroxy-3-methylphenylisopropyl)phenol, 2,4-bis(4-hydroxy-3,5-dimethylphenylisopropyl)phenol, tetrakis(4-hydroxy-3-methylphenyl)methane, tetrakis(4-hydroxy-3,5-dimethylphenyl)methane, tetrakis(4-[4-hydroxy-3-methylphenylisopropyl]-phenoxy)methane, tetrakis(4-[4-hydroxy-3,5-dimethylphenylisopropyl]-phenoxy)methane, and combinations thereof.

11. The method of claim 1, wherein the polyhydric phenol comprises a dihydric phenol and a polyhydric phenol comprising 3 to 8 phenolic hydroxy groups.

12. The method of claim 1, wherein the monohydric phenol and the polyhydric phenol are copolymerized in a mole ratio of about 3 to about 110.

13. The method of claim 1, wherein the aromatic hydrocarbon solvent is selected from benzene, toluene, xylenes, and combinations thereof.

14. The method of claim 1, wherein the aromatic hydrocarbon solvent comprises toluene.

15. The method of claim 1, wherein the solvent further comprises a C₃-C₈ aliphatic alcohol.

16. The method of claim 14, wherein the solvent further comprises ethanol, methanol, or a combination thereof.

17. The method of claim 1, wherein the monohydric phenol, the polyhydric phenol, and the solvent are used in amounts such that a ratio of the total weight of the monohydric phenol and the polyhydric phenol to the total weight of the monohydric phenol, the polyhydric phenol, and the solvent is about 0.1:1 to about 0.5:1.

18. The method of claim 1, wherein the metal ion is selected from ions of copper, manganese, cobalt, iron, and combinations thereof.

19. The method of claim 1, wherein the metal ion comprises copper ion.

20. The method of claim 1, wherein the nitrogen-containing ligand is selected from alkylenediamine ligands, primary monoamines, secondary monoamines, tertiary monoamines, aminoalcohols, oximes, oxines, cyanide, and combinations thereof.

21. The method of claim 1, wherein the nitrogen-containing ligand is selected from dibutylamine, dimethylbutylamine, N,N′-di-t-butylethylenediamine, pyridine, and combinations thereof.

22. The method of claim 1, wherein the nitrogen-containing ligand comprises dibutylamine, dimethylbutylamine, and N,N′-di-t-butylethylenediamine.

23. The method of claim 1, wherein said oxidatively copolymerizing a monohydric phenol and a polyhydric phenol comprises adding all of the monohydric phenol and all of the polyhydric phenol to the reactor before initiating polymerization.

24. The method of claim 1, wherein said oxidatively copolymerizing a monohydric phenol and a polyhydric phenol comprises adding all of the polyhydric phenol to the reactor before initiating polymerization, and adding an amount of the monohydric phenol before initiating polymerization such that a molar ratio of monohydric phenol to polyhydric phenol is about 0.1 to about 30 before initiating polymerization.

25. The method of claim 1, wherein said oxidatively copolymerizing a monohydric phenol and a polyhydric phenol comprises adding an amount of the polyhydric phenol and an amount of the monohydric phenol and an amount of the solvent to the reactor before initiating polymerization, such that a ratio of the total of the amount of the polyhydric phenol and the amount of the monohydric phenol to the total of the amount of the polyhydric phenol and the amount of the monohydric phenol and the amount of the solvent is about 0.1:1 to about 0.5:1.

26. The method of claim 1, wherein said oxidatively copolymerizing a monohydric phenol and a polyhydric phenol comprises maintaining a reaction temperature of about 20 to about 80° C.

27. The method of claim 1, wherein said oxidatively copolymerizing a monohydric phenol and a polyhydric phenol comprises maintaining an oxygen flow rate of about 0.1 to about 3 moles O₂ per hour per total moles of monohydric phenol and polyhydric phenol.

28. The method of claim 1, wherein said oxidatively copolymerizing a monohydric phenol and a polyhydric phenol is conducted over the course of about 0.5 to about 5 hours.

29. The method of claim 1, wherein said oxidateively copolymerizing a monohydric phenol and polyhydric phenol comprises using a catalyst metal ion concentration of about 0.0001 to about 0.01 mole per total moles of monohydric phenol and polyhydric phenol.

30. The method of claim 1, wherein said catalyst further comprises a halide ion, and wherein a ratio of total moles of metal ion, nitrogen-containing ligand, and halide ion to total moles of monohydric phenol and polyhydric phenol is about 0.005 to about 0.5.

31. The method of claim 1, wherein the polyfunctional poly(arylene ether) has an intrinsic viscosity of about 0.04 to about 0.15 deciliter per gram at 25° C. in chloroform.

32. The method of claim 1, wherein the chelating agent is selected from polyalkylenepolyamine polycarboxylic acids, aminopolycarboxylic acids, aminocarboxylic acids, polycarboxylic acids, alkali metal salts of the foregoing acids, alkaline earth metal salts of the foregoing acids, mixed alkali metal-alkaline earth metal salts of the foregoing acids, and combinations thereof.

33. The method of claim 1, wherein the chelating agent is selected from nitrilotriacetic acid, ethylenediaminetetraacetic acid, alkali metal salts of the foregoing acids, alkaline earth metal salts of the foregoing acids, mixed alkali metal-alkaline earth metal salts of the foregoing acids, and mixtures thereof.

34. The method of claim 1, wherein the chelating agent comprises nitrilotriacetic acid or an alkali metal salt of nitrilotriacetic acid.

35. The method of claim 1, wherein the chelating agent and metal ion are present in a molar ratio of about 1.1 to about 1.4.

36. The method of claim 1, wherein the chelating agent and metal ion are present in a molar ratio of about 1.1 to about 1.3.

37. The method of claim 1, wherein said contacting the polyfunctional poly(arylene ether) solution with an aqueous solution of a chelating agent is conducted at a temperature of about 30 to about 90° C.

38. The method of claim 1, wherein said contacting the polyfunctional poly(arylene ether) solution with an aqueous solution of a chelating agent comprises maintaining a ratio of a polyfunctional poly(arylene ether) solution density to an aqueous solution density of about 0.6 to about 1.0.

39. The method of claim 1, wherein said contacting the polyfunctional poly(arylene ether) solution with an aqueous solution of a chelating agent comprises maintaining a polyfunctional poly(arylene ether) solution viscosity of about 0.5 to about 3,000 centipoise.

40. The method of claim 1, wherein said contacting the polyfunctional poly(arylene ether) solution with an aqueous solution of a chelating agent comprises maintaining a ratio of a polyfunctional poly(arylene ether) solution viscosity to an aqueous solution viscosity of about 0.5 to about 3,000.

41. The method of claim 1, wherein said oxidatively copolymerizing a monohydric phenol and a polyhydric phenol comprises agitating with a mixing energy of about 10 to about 150 kilojoules per kilogram total of the monohydric phenol, the polyhydric phenol, the solvent, and the catalyst.

42. The method of claim 1, wherein said contacting the polyfunctional poly(arylene ether) solution with an aqueous solution of a chelating agent comprises agitating the polyfunctional poly(arylene ether) solution with the aqueous solution with a mixing energy of about 0.5 to about 25 kilojoules per kilogram total of the polyfunctional poly(arylene ether) solution and the aqueous solution.

43. The method of claim 1, wherein said contacting the polyfunctional poly(arylene ether) solution with an aqueous solution of a chelating agent comprises agitating the polyfunctional poly(arylene ether) solution with the aqueous solution for about 5 to about 120 minutes.

44. The method of claim 1, wherein said contacting the polyfunctional poly(arylene ether) solution with an aqueous solution of a chelating agent comprises agitating the polyfunctional poly(arylene ether) solution with the aqueous solution, and subsequently leaving the polyfunctional poly(arylene ether) solution and the aqueous solution in contact without agitation for about 1 to about 30 hours.

45. The method of claim 1, further comprising adding solvent to the polyfunctional poly(arylene ether) solution prior to said contacting the polyfunctional poly(arylene ether) solution with an aqueous solution of a chelating agent.

46. The method of claim 1, wherein said contacting the polyfunctional poly(arylene ether) solution with an aqueous solution of a chelating agent further comprises contacting the polyfunctional poly(arylene ether) solution and the aqueous solution with additional water.

47. The method of claim 1, wherein said contacting the polyfunctional poly(arylene ether) solution with an aqueous solution of a chelating agent comprises using the chelating agent in an amount of about 0.01 to about 0.1 weight percent based on the total weight of polyfunctional poly(arylene ether) solution and the aqueous solution of the chelating agent.

48. The method of claim 1, wherein said contacting the polyfunctional poly(arylene ether) solution with an aqueous solution of a chelating agent comprises using the chelating agent in an amount of about 0.5 to about 50 weight percent based on the total weight of the aqueous solution of the chelating agent

49. The method of claim 1, further comprising isolating the polyfunctional poly(arylene ether), wherein the isolated polyfunctional poly(arylene ether) has a concentration of catalyst metal of about 2 to about 5 parts per million by weight.

50. A method of preparing a poly(arylene ether) resin, comprising:
oxidatively copolymerizing a monohydric phenol and an alkylidenediphenol in an aromatic hydrocarbon solvent in the presence of a catalyst comprising a metal ion and a nitrogen-containing ligand to form a solution comprising a bifunctional poly(arylene ether) having an intrinsic viscosity of about 0.04 to about 0.20 deciliter per gram at 25° C. in chloroform; and
contacting the bifunctional poly(arylene ether) solution with an aqueous solution of a chelating agent to extract the metal ion from the solution; wherein the chelating agent and metal ion are present in a molar ratio of about 1.0 to about 1.4;
wherein the monohydric phenol is selected from 2,6-dimethylphenol, 2,3,6-trimethylphenol, and mixtures thereof;
wherein the alkylidenediphenol has the structure 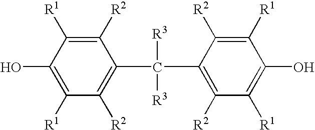
wherein each occurrence of R¹ is methyl; each occurrence of R² is independently hydrogen or methyl; and each occurrence of R³ is independently hydrogen or methyl;
wherein the aromatic hydrocarbon solvent is selected from benzene, toluene, xylenes, and combinations thereof;
wherein the chelating agent is selected from nitrilotriacetic acid, ethylenediaminetetraacetic acid, alkali metal salts of the foregoing acids, alkaline earth metal salts of the foregoing acids, mixed alkali metal-alkaline earth metal salts of the foregoing acids, and mixtures thereof; and
wherein said contacting the bifunctional poly(arylene ether) solution with an aqueous solution of a chelating agent is conducted with agitation at about 40 to about 85° C., for about 15 to about 120 minutes, with a mixing energy of about 5 to about 20 kilojoules per kilogram total of the bifunctional poly(arylene ether) solution and the aqueous solution.

51. A method of preparing a poly(arylene ether) resin, comprising:
oxidatively copolymerizing 2,6-dimethyphenol and 2,2-bis(3,5-dimethyl-4-hydroxyphenyl)propane in toluene in the presence of a catalyst comprising copper ion and a nitrogen-containing ligand to form a solution comprising a bifunctional poly(arylene ether) having an intrinsic viscosity of about 0.04 to about 0.15 deciliter per gram at 25° C. in chloroform; and
contacting the bifunctional poly(arylene ether) solution with an aqueous solution of nitrilotriacetic acid trisodium salt to extract the copper ion from the solution; wherein the nitrilotriacetic acid trisodium salt and copper ion are present in a molar ratio of about 1.1 to about 1.4;
wherein the 2,6-dimethyphenol, the 2,2-bis(3,5-dimethyl-4-hydroxyphenyl)propane, and the toluene are used in amounts such that the ratio of the total weight of the 2,6-dimethyphenol and the 2,2-bis(3,5-dimethyl-4-hydroxyphenyl)propane to the total weight of the 2,6-dimethyphenol, the 2,2-bis(3,5-dimethyl-4-hydroxyphenyl)propane, and the toluene is about 0.26:1 to about 0.34:1;
wherein the nitrogen-containing ligand comprises dibutylamine, dimethylbutylamine, and N,N′-di-t-butylethylenediamine;
wherein said contacting the bifunctional poly(arylene ether) solution with an aqueous solution of a chelating agent is conducted with agitation at about 50 to about 80° C., for about 15 to about 120 minutes, with a mixing energy of about 5 to about 15 kilojoules per kilogram total of the bifunctional poly(arylene ether) solution and the aqueous solution;
wherein said contacting the bifunctional poly(arylene ether) solution with an aqueous solution of nitrilotriacetic acid trisodium salt comprises maintaining a ratio of a bifunctional poly(arylene ether) solution viscosity to an aqueous solution viscosity of about 5 to about 500; and
wherein said contacting the bifunctional poly(arylene ether) solution with an aqueous solution of nitrilotriacetic acid trisodium salt comprises maintaining a ratio of a bifunctional poly(arylene ether) solution density to an aqueous solution density of about 0.8 to about 1.0.
